(19) United States
(12) Patent Application Publication
(10) Pub. No.: US 2017/0254306 A1
(43) Pub. Date: Sep. 7, 2017

(54) Inlet Control Valve With Snap-Off Coil Assembly

(71) Applicant: Stanadyne LLC, Windsor, CT (US)

(72) Inventor: Robert G. Lucas, Ellington, CT (US)

(21) Appl. No.: 15/411,142

(22) Filed: Jan. 20, 2017

Related U.S. Application Data
(63) Continuation-in-part of application No. 15/062,774, filed on Mar. 7, 2016.

(51) Int. Cl. F02M 59/46; F16K 27/04; F04B 7/00

(52) U.S. Cl. CPC F02M 59/466; F04B 7/0076; F16K 27/048

(57) ABSTRACT

In a solenoid actuated inlet control valve for a fuel pump, the risk of fuel leakage from the control valve in the event of damage to the electromagnetic actuator for the inlet control valve is reduced by hydraulically isolating an actuation module containing the electromagnetic coil from a delivery module containing the hydraulic flow paths, and providing a breakaway connection between the actuation module and the delivery module.

### BACKGROUND

The present invention relates to high pressure fuel pumps, and particularly to the inlet valve for feeding low pressure fuel to the high pressure pumping chamber.

Single piston and multi-piston high pressure common rail fuel pumps have been implemented to provide the high fuel pressures required by modern direct injected gasoline and diesel engines. These engine mounted pumps are volume controlled to minimize parasitic losses while maintaining rail pressure. Volume control is achieved either by inlet throttling using a magnetic proportional control valve, or indirect digital control of the inlet valve by a magnetic actuator. Either execution requires that the pump be controlled by an electrical signal from the engine ECU.

Because the indirect inlet valve actuator control requires a separate actuator for each pump piston, it has become common for multi-piston pumps to use a single inlet throttling proportional valve, in order to avoid a high part count and cost. Many modern single piston pumps use an indirect inlet valve actuator with a separate magnetically controlled armature assembly. These devices typically employ three separate components: inlet valve, magnetic armature, and the intervening engaging or connecting member.

Co-pending U.S. patent application Ser. No. 15/062,774, filed Mar. 7, 2016 for Direct Magnetically Controlled Inlet Valve for Fuel Pump, discloses an improved inlet valve assembly and associated pump, according to which a direct a magnetic flux path is directly applied to the inlet valve member when a coil is energized. As a result, direct actuation of the inlet valve is achieved, thereby eliminating the separate armature and armature to inlet valve connecting member, and reducing cost. By eliminating the separate armature and connecting member, reciprocating masses are reduced. Mass reduction minimizes impact generated noise and reduces response time for better controllability and lower power consumption.

As safety requirements dictate, there is a need to assure that in the event of a collision, the collapsing engine bay does not damage the inlet valve to the extent that fuel leaks from the pump, presenting a fire hazard. A vulnerable part of the pump is the electromagnetic actuator for the inlet control valve.

### SUMMARY

The primary purpose of the present invention is to reduce the risk of fuel leakage from the inlet control valve in the event of damage to the electromagnetic actuator for the inlet control valve. This is achieved by hydraulically isolating an actuation module containing the electromagnetic coil from a delivery module containing the hydraulic flow paths, and providing a breakaway connection between the actuation module and the delivery module.

Preferably, the actuation module is attached to the lower portion of the delivery module such that it projects entirely external to the housing. The snap off or breakaway connection preserves the hydraulic integrity of the pump.

In one embodiment, the inlet valve comprises a fuel delivery module mountable in the pump housing, including an inflow passage for receiving feed fuel from an inlet port, a delivery passage for delivering feed fuel to the pumping chamber, a valve seat between the inflow passage and the delivery passage, and a valve member movable between a first position against the seat to close fuel flow to the delivery passage and a second position to open fuel flow to the delivery passage. An actuation module is attached to the delivery module, including an electromagnetic coil assembly that is operatively associated with the valve member for moving the valve member between the first and second positions. The actuation module is hydraulically isolated from the fuel delivery module, so that even if the actuation module is completely severed from the pump, no fuel will leak out of the control valve.

Another embodiment is directed to a fuel pump comprising a housing, an inlet port for receiving low pressure feed fuel, a pumping chamber within the housing for pressurizing the feed fuel, an outlet port for discharging the pressurized fuel, a fuel delivery module, and an actuator module. The fuel delivery module is mounted in the housing, and includes a valve member movable between a first position and a second position to control infeed flow to the pumping chamber. An actuation module is attached to at least one of the delivery module and housing, including an electromagnetic coil assembly that is operatively associated with the valve member for moving the valve member between the first and second positions. The actuation module is hydraulically isolated from the fuel delivery module.

The actuation module preferably attached to the delivery module with a snap off connection, thereby serving as a sacrificial body to minimize collision forces transferred to the delivery module, which contains fuel. For example, the actuation module can be tack welded to the delivery module.

The present invention can be incorporated into many kinds of inlet control valves, but is most easily incorporated into the kind of magnetically actuated valve described in said co-pending application. In this embodiment, the actuation module has a first magnetic pole, a surrounding coil, and a magnetically conductive outer jacket. The valve member in the delivery module is ferromagnetic, and the lower portion of the delivery module defines a second magnetic pole magnetically coupled to the first magnetic pole. Portions of the housing, the actuation module, and the delivery module define a magnetic circuit, whereby actuation of the electromagnetic coil applies or removes a force to move the valve member between the first and second positions. The delivery module is internal to the housing, the lower portion is hydraulically sealed against the housing. The actuation module is attached to the lower portion of the delivery module and projects entirely external to the housing, so that it can be snapped off while the housing protects the delivery module.

### BRIEF DESCRIPTION OF THE DRAWING

Representative embodiments will be described in detail with reference to the accompanying drawing, wherein:

FIG. 1 is a section view of a single piston common rail fuel pump of a type that can be readily adapted for incorporating the invention;

FIG. 2 is a cross-sectional view of the pump of FIG. 1, in a different plane;

FIG. 3 is an enlarged section view of the inlet valve assembly of FIG. 2;

FIG. 4 is a section view through the pump, orthogonal to the view of FIG. 3, showing the inlet fuel flowpath from the inlet fitting to the inlet valve assembly;

FIG. 5 is a section view of a control valve of the type described with respect to FIGS. 1-4, modified to incorporate a preferred embodiment of the present invention; and

FIG. 6 is a more detailed view of the control valve of FIG. 5.

### DETAILED DESCRIPTION

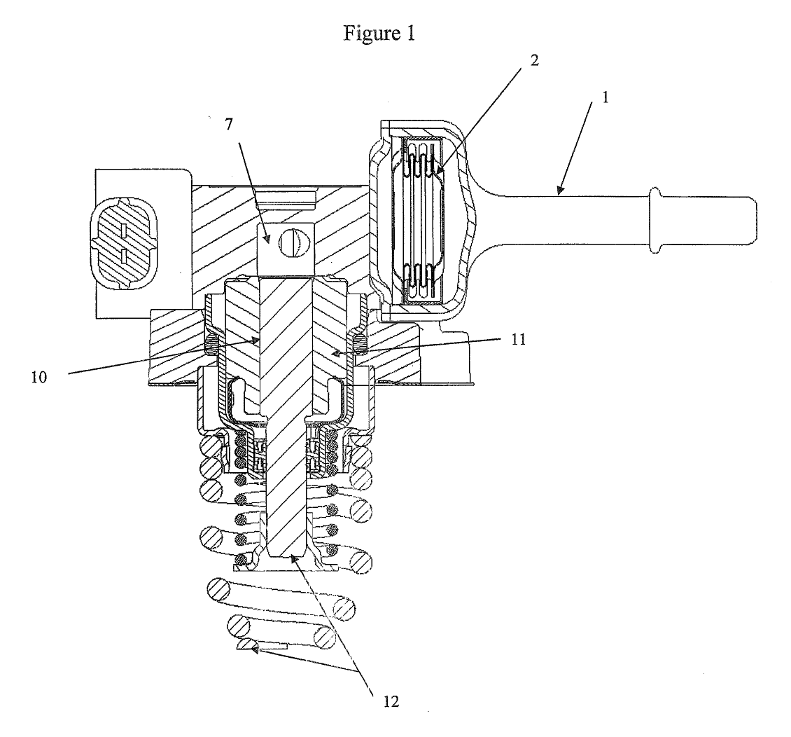

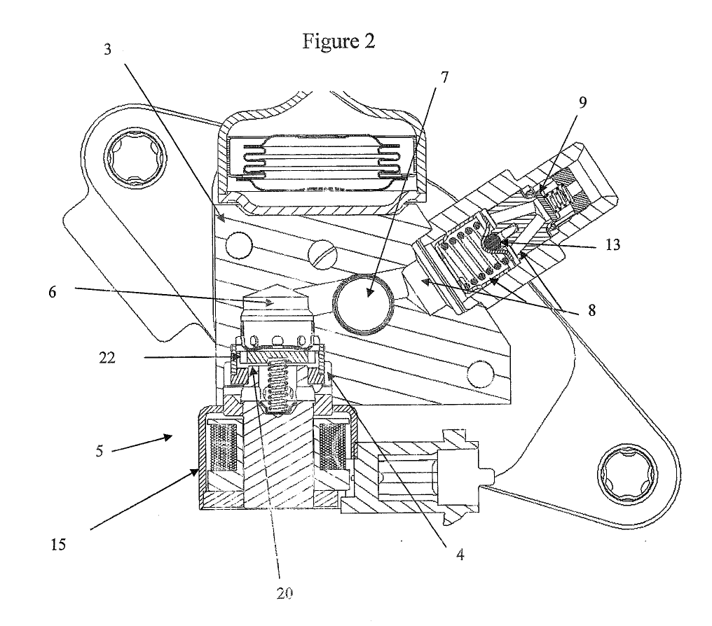

The improved inlet valve and associated pump will be described in the context of a pump in which a direct magnetic flux path produces a magnetic force that is directly applied to the inlet valve member when the coil is energized. The basic functional aspects are evident from FIGS. 1 and 2. During the pump charging phase when piston 10 is reciprocally moving away from pumping chamber 7, low pressure feed fuel enters the pump through inlet fitting or port 1, passes around the pressure damper 2 and then into the pump housing 3 and a series of low pressure passages. It then enters into inlet annulus 4 for the direct magnetically controlled inlet valve assembly 5, passes around the direct magnetically controlled inlet valve 22 through the passage 6 for delivery into the pumping chamber 7. Upon completion of the charging phase the pumping camshaft acts upon a tappet 12, urging the piston 10 to slide in piston sleeve 11. When the direct magnetically controlled inlet valve assembly 5 is energized with an electrical current to coil assembly 15, a magnetic force is generated urging the inlet valve 22 to close and seal at surface 20, thereby enabling fuel trapped in the pumping chamber 7 to compress and build pressure. When sufficient pressure is built, the outlet valve 9 will open, allowing high pressure discharge flow to pass from the pumping chamber through the high pressure passages 8 past the outlet valve 9 and into the high pressure line, rail, and finally to feed the fuel injectors. The pump is equipped with a relief valve 13 in case there is a system malfunction.

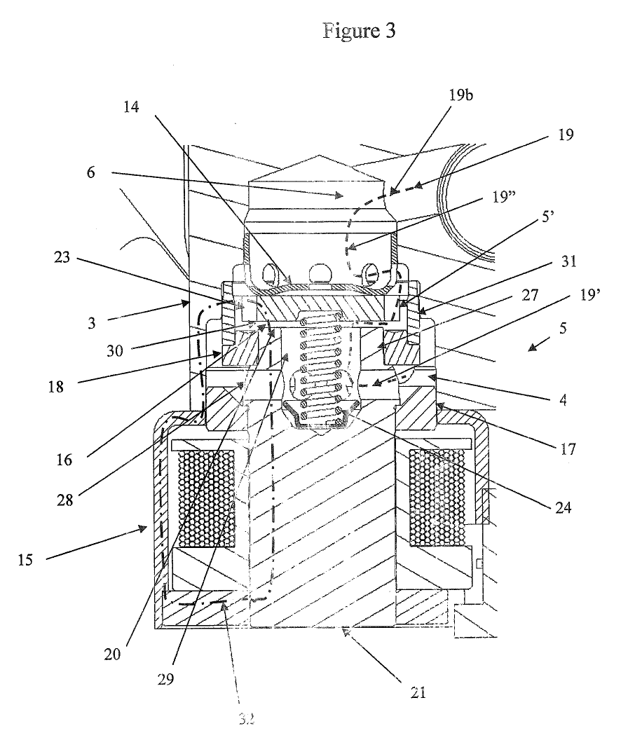

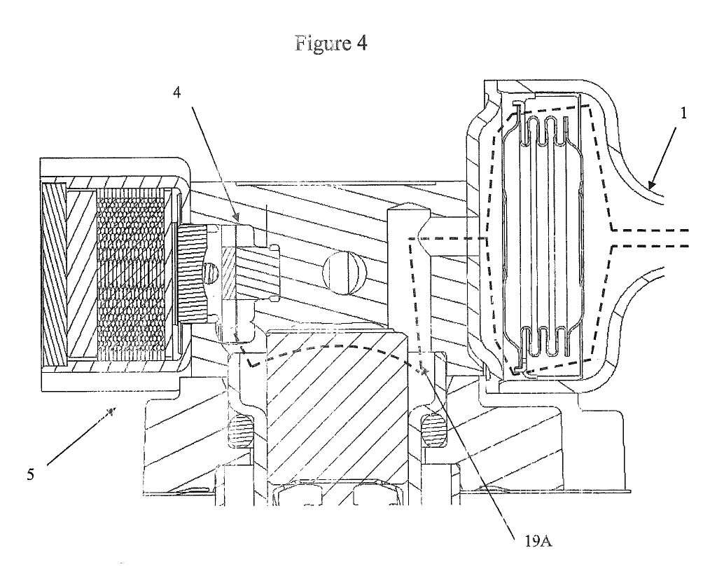

FIGS. 3 and 4 provide more detail. When the direct magnetically controlled inlet valve assembly 5 is de-energized during the charging phase of the pump, valve member 22 opens and fuel is allowed to pass along inlet fluid flow path circuit 19. During the charging phase fuel flows along path portion 19a from inlet fitting 1 to inlet valve inlet annulus 4, through the inlet valve 5, then along path portion 19b through passage 6 toward the pumping chamber. In the disclosed embodiment, the valve assembly 5 functions as both an inlet check valve and a quantity metering valve. During the charging phase, the downward movement of the pumping piston fills the pumping chamber with low pressure fuel from the inlet circuit 19. During the high pressure pumping phase of the piston, highly pressurized fuel cannot be permitted to backflow through passage 19′ to the inlet fitting. During this phase the valve member 22 is closed against sealing surface 20, due to both the energization of the coil and the high pressure fuel acting on the top surface of the valve member 22. In order to control the quantity (volume) pumped at high pressure, the energization of the coil is timed to close the valve member 22 corresponding to a certain position on the upward stroke of the cam/piston. Prior to the valve closure, when the piston is moving upward, low pressure is being pushed backwards from the pumping chamber past the inlet valve 22 all the way to the pressure dampers 2 and inlet fitting 1. The dampers absorb much of the pressure spike associated with this backflow. This can be considered a “pumping bypass” phase of the overall piston reciprocation cycle. The overall cycle thus comprises a charging phase, a pumping bypass phase, and a high pressure pumping phase.

In a known manner, the electromagnetic coil assembly 15 is analogous to a solenoid, with a multi-winding coil situated around an axially extending, ferromagnetic cylinder or rod 21 (hereinafter referred to as magnetic pole). One end of the pole projects from the coil. When an electrical current is passed through the coil assembly 15, a magnetic field is generated, which flows about the magnetic circuit along magnetic flux lines across radial air gap 23, generating an axial force onto the face of the valve 22 via the varying magnetic air gap 16. When the magnetic force exceeds the force of the inlet valve return spring 24, the valve 22 will close against valve sealing surface 20. The magnetic pole 21 integrally defines sealing surface 20 and is also a part of the magnetic flux path 32. Preferably, an inlet valve stop 14 aids in positioning of the valve 22 for accurate stroke control.

First magnetic break 17 and second magnetic break 18 surround the sealing face 20 to direct the correct magnetic flow path and avoid a magnetic short circuit. Both breaks 17 and 18 should be fabricated from a non-magnetic material and for best performance valve stop 14 should also be fabricated from a non-magnetic material. Breaks 17 and 18 surround the projecting portion of the magnetic pole to prevent magnetic flux from travelling radially to the housing from the pole and thereby short-circuiting the valve member 22. The breaks thereby assure that the flux circuit passes through the coils, the magnet pole, through the sealing surface 20 and air gap 16, through the inlet valve member 22, across radial air gap 23, through conductive ring 31 and pump housing 3, back to the coil 15. In an alternative embodiment, the sealing surface 20′ is not unitary with the pole 21; it could be integrated with the second magnetic break 18.

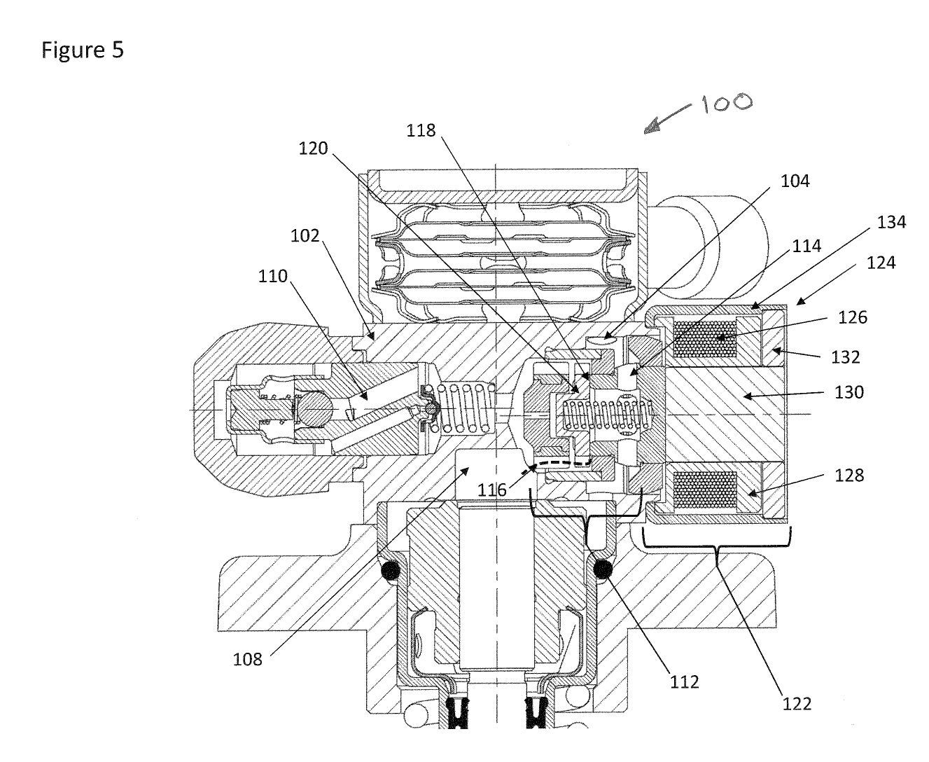

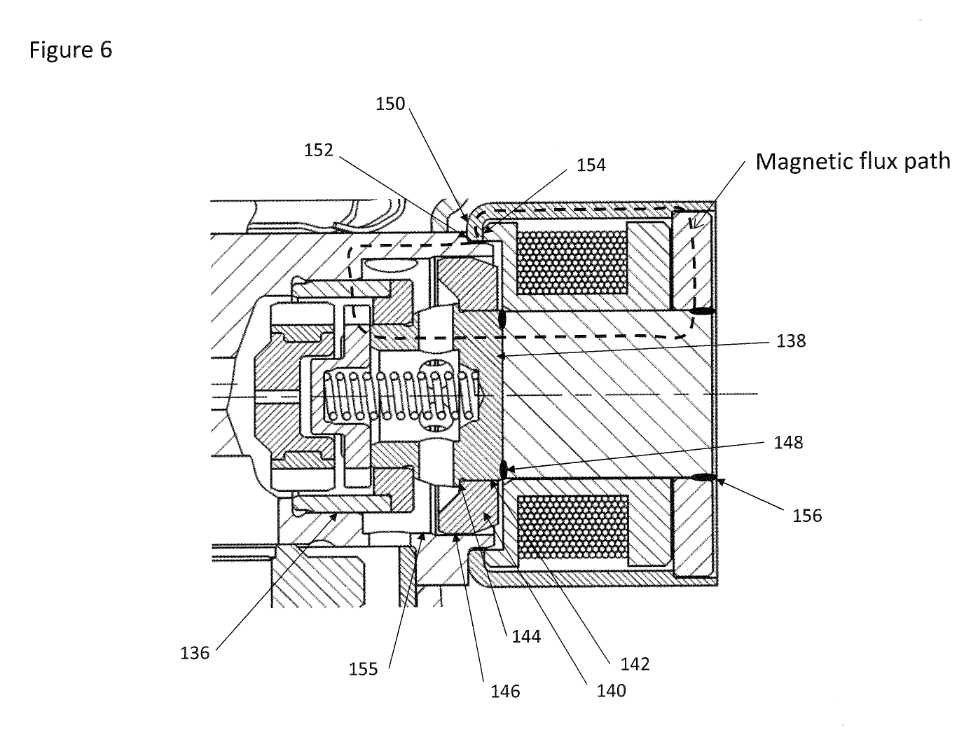

FIGS. 5 and 6 show a pump embodiment 100 of the present invention that improves upon the inlet valve shown in FIGS. 1-4, wherein the inlet valve features a distinct actuator module containing the coil assembly and a distinct delivery module containing all the hydraulic flow paths of the overall inlet valve.

The pump comprises a housing 102, an inlet port 104 for receiving low pressure feed fuel, a pumping chamber 108 within the housing for pressurizing the feed fuel, and an outlet port 110 for discharging the pressurized fuel. A fuel delivery module 112 is mounted in the housing, including an inflow passage 114 for receiving feed fuel from the inlet port, a delivery passage 116 for delivering feed fuel to the pumping chamber, a valve seat 118 between the inflow passage and the delivery passage, and a valve member 120 movable between a first position against the seat whereby the valve member closes fuel flow to the delivery passage and a second position away from the seat whereby the valve member retracts from the seat to open fuel flow to the delivery passage. An actuation module 122 is attached to at least one of the delivery module 112 and housing 102, and includes an electromagnetic coil 124 assembly that is operatively associated with the valve member for moving the valve member between the first and second positions. The actuation module is hydraulically isolated from the fuel delivery module.

The actuation module 122 has a coil 126 supported by a coil housing 128, a central pole 130 within the coil housing, a base 132, and a conductive jacket 134 that surrounds the coil housing and the base.

The delivery module 112 is internal to the housing 102 and the actuation module 122 is external to the housing. The delivery module is mounted and radially sealed such as at 136 in a profiled bore 155 in the housing. An axially outer portion 138 constitutes a pole that coaxially confronts the central pole 130 of the actuation module, and an outer seal ring 140 with a radially inner surface that aligns and seals the pole via a lip 142 and shoulder 144 and a radially outer surface that sealingly bears against the wall of the housing bore at 146 as a press-fit or weld. Together the pole and ring of the delivery module and the bore wall of the housing hydraulically isolate the hydraulic internals of the delivery module 112 from the actuation module 122.

In a manner readily derivable from FIGS. 1-4, portions of the housing 102, the actuation module 122, and the delivery module 112 define a magnetic circuit, whereby actuation of the electromagnetic coil applies or removes a force to move the valve member 120 between the first and second positions.

The actuation module 122 is attached to the axially outer portion 138 of the delivery module 112 such that it projects entirely external to the housing 102. The actuation module 122 is attached to the delivery module 112 with a snap off or breakaway connection. For example, the pole 130 of the actuation module is tack welded 148 to pole 138 of the delivery module. The jacket 134 has an upper end including a lip 150 that is captured between a shoulder 152 on the housing and a counter shoulder 154 on the coil housing. The coil, coil housing, conductive jacket, and base form a unit that is fastened to the central pole 130 with a weld 156 or the like.

1. An inlet valve for a fuel pump having a pump housing, an inlet port for receiving low pressure feed fuel, a pumping chamber within the housing for pressurizing the feed fuel, and an outlet port for discharging the pressurized fuel, comprising:
a fuel delivery module mountable in the pump housing, including an inflow passage for receiving feed fuel from the inlet port, a delivery passage for delivering feed fuel to the pumping chamber, a valve seat between the inflow passage and the delivery passage, and a valve member movable between a first position against the seat whereby the valve member closes fuel flow to the delivery passage and a second position away from the seat whereby the valve member retracts from the seat to open fuel flow to the delivery passage;
an actuation module attached to the delivery module, including an electromagnetic coil assembly that is operatively associated with the valve member for moving the valve member between the first and second positions;
wherein the actuation module is hydraulically isolated from the fuel delivery module.

2. The inlet valve of claim 1, wherein the actuation module is attached to the delivery module with a snap off connection.

3. The inlet valve of claim 2, wherein the actuation module is tack welded to the delivery module.

4. The inlet valve of claim 1, wherein
the valve member is magnetic;
a magnetic pole confronts the valve member;
the coil is selectively energizable for generating a magnetic flux directly magnetically coupling the pole and the valve member;
whereby the valve member is movable between said first and second positions in response to the energized state of the coil.

5. The inlet valve of claim 4, wherein the valve member constitutes an armature in relation to the coil and a magnetic air gap is defined between the valve member and the magnetic pole.

6. The inlet valve of claim 5, wherein the valve member has a sealing face that mates with said sealing surface, and the magnetic force is applied at said sealing face.

7. A fuel pump comprising:
a housing;
an inlet port for receiving low pressure feed fuel;
a pumping chamber within the housing for pressurizing the feed fuel;
an outlet port for discharging the pressurized fuel;
a fuel delivery module mounted in the housing, including an inflow passage for receiving feed fuel from the inlet port, a delivery passage for delivering feed fuel to the pumping chamber, a valve seat between the inflow passage and the delivery passage, and a valve member movable between a first position against the seat whereby the valve member closes fuel flow to the delivery passage and a second position away from the seat whereby the valve member retracts from the seat to open fuel flow to the delivery passage;
an actuation module attached to at least one of the delivery module and housing, including an electromagnetic coil assembly that is operatively associated with the valve member for moving the valve member between the first and second positions;
wherein the actuation module is hydraulically isolated from the fuel delivery module.

8. The pump of claim 7, wherein the delivery module is internal to the housing and the actuation module is external to the housing.

9. The pump of claim 7, wherein
the delivery module is mounted in a bore in the housing and has a lower portion that is hydraulically sealed against said bore; and
the actuation module is attached to the lower portion of the delivery module.

10. The pump of claim 10, wherein
the actuation module has a first magnetic pole, a surrounding coil, and a magnetically conductive outer jacket;
the valve member is ferromagnetic;
the lower portion of the delivery module defines a second magnetic pole magnetically coupled to the first magnetic pole;
portions of the housing, the actuation module, and the delivery module define a magnetic circuit;
whereby actuation of the electromagnetic coil applies or removes a force to move the valve member between the first and second positions.

11. The pump of claim 10, wherein
the delivery module is internal to the housing and has a lower portion that is hydraulically sealed against housing;
the actuation module is attached to the lower portion of the delivery module and projects entirely external to the housing.

12. The pump of claim 11, wherein
the actuation module is attached to the delivery module with a snap off connection.

13. The pump of claim 11, wherein the actuation module is tack welded to the delivery module.

14. The pump of claim 13, wherein said jacket has an upper end including a lip that is captured between a shoulder on said housing and a counter shoulder on the actuation module.
